(19) United States
(12) Patent Application Publication
(10) Pub. No.: US 2008/0191148 A1
(43) Pub. Date: Aug. 14, 2008

(54) Radioisotope Generation System Having Partial Elution Capability

(76) Inventor: Chad M. Gibson, Cincinnati, OH (US)

Correspondence Address: Mallinckrodt Inc., 675 McDonnell Boulevard, HAZELWOOD, MO, 63042, US

(21) Appl. No.: 11/995,749

(22) PCT Filed: Aug. 8, 2006
(86) PCT No.: PCT/US2006/030766

§ 371 Date: Jan. 15, 2008

Related U.S. Application Data
(60) Provisional application No. 60/706,793, filed on Aug. 9, 2005.

(51) Int. Cl. G21G 1/00

(52) U.S. Cl. 250/432 PD

(57) ABSTRACT

In a radioisotope generation system (101) and method for dispensing a radioactive eluate, a radioisotope generator (103) is operable to dispense the eluate. During dispensing, a monitoring system (151) may monitor the dispensed amount of eluate and may generate a signal indicative of the amount of eluate dispensed. In particular embodiments, the monitoring system may generate a signal corresponding to the dispensing of a desired amount of eluate. The monitoring system may particularly monitor the level of fluid in a cavity (133) or container into which the eluate is dispensed, the weight of the eluate dispensed, an elapsed time during which the eluate is dispensed, and/or other characteristic of the dispensed eluate, each of which may be corresponded to the amount of dispensed eluate. The system may be equipped with an interruption system that interrupts the dispensing of the eluate in response to the signal generated by the monitoring system.

### FIELD OF THE INVENTION

The present invention relates generally to radioisotope generation systems, and more particularly to radioisotope generation systems that facilitate dispensing of a desired amount of eluate from a radioisotope generator.

### BACKGROUND

Radioisotope generators are used to obtain a solution comprising a daughter radioisotope (e.g., technetium-99) from a parent radioisotope (e.g., molybdenum-99) which produces the daughter radioisotope by radioactive decay. One common radioisotope generator includes a column containing the parent radioisotope adsorbed on a carrier medium (e.g., alumina). The carrier medium has a relatively higher adsorptive capacity for the parent radioisotope and a relatively lower adsorptive capacity for the daughter radioisotope. As the parent radioisotope decays, a quantity of the desired daughter radioisotope is produced in the column. The column can be washed by passing a suitable eluant (e.g., a sterile saline solution) through the column such that the resulting eluate contains the daughter radioisotope (e.g., in the form of a dissolved salt), which makes the eluate useful in nuclear medicine. For example, the eluate may be adapted for intravenous administration for any of a variety of diagnostic and/or therapeutic procedures.

To obtain a quantity of the eluate from the generator, a container (e.g., a vial) may be connected to an outlet of the column at a tapping point of the generator to receive the eluate containing the daughter radioisotope. The container may be an evacuated container, in which case the partial vacuum in the container is used to draw eluant through the column from an eluant reservoir in fluid communication with an inlet to the column, thereby eluting the daughter radioisotope from the column. Using vacuum pressure in the container to draw eluate out of the generator avoids the need to pressurize the radioactive materials, as would be the result if the fluids were pumped through the column, thereby reducing the risk of accidental release of radioactive materials.

Another advantage of using vacuum pressure in the container to draw eluate out of the generator column is the elimination of the need for moving parts to cause the fluid flow. This may make the system more resistant to mechanical failure and may also render operation of the system relatively simple and clean. Because the eluate may be dispensed directly from the outlet of the generator column to the container, there is no need to clean an intermediate chamber/reservoir of the type used in some prior art systems (e.g., U.S. Pat. No. 4,625,118). Unnecessary cleaning is not only undesirable from the standpoint of the cost (in materials and time) of the cleaning itself, but in some circumstances trace residues of cleaning chemicals can also have a negative impact of the yield from the system, as noted in U.S. Pat. No. 5,580,541. Thus, the simplicity of using vacuum pressure in an evacuated container to draw eluate from the generator directly into the container is desirable for a variety of reasons.

The same generator column may be used to fill a number of containers with eluate before the radioisotopes in the column are spent. The amount of eluate needed at any time may vary depending on the number of prescriptions that need to be filled by the radiopharmacy and/or the remaining concentration of radioisotopes in the generator column. One way to vary the amount of eluate drawn from the column is to vary the volume of the containers. For example, different sized containers having volumes ranging from about 5 mL to about 30 mL are common. In particular, standard elution vials having volumes of 5 mL, 10 mL, or 20 mL are currently available in the industry and may be used to facilitate dispensing of the corresponding amount of eluate from the generator column.

Unfortunately, the use of multiple different types of containers has significant disadvantages. For example, a radiopharmacy may use different labels, rubber stoppers, flanged metal caps, lead shields, and/or spacers to handle different sized containers, requiring the radiopharmacy to keep supplies of these items in stock for each type of container. Likewise, packaging for transport of the filled containers to healthcare facilities must also account for the different dimensions of the containers.

Another way to vary the amount of eluate dispensed to a container is to interrupt the elution process before the container is completely filled. For example, U.S. Pat. No. 4,387,303 discloses a system that permits an elution process to be interrupted before the container is completely filled. In particular, the radiopharmacist estimates when to interrupt the dispensing process based on a desire to only partially fill the container to a certain amount. The process is interrupted simply by manually removing the container from the generator tap. By interrupting the elution process at the right time, the container could be partially filled to obtain any desired amount of eluate equal to or less than the capacity of the vial. Another advantage of interrupting the elution process before a container is filled to capacity is that it is easier to draw the eluate from the container when it is not completely filled.

Unfortunately, it is not easy to identify the level of the eluate in a partially filled container. For instance, the container may be housed in a radiation shield that prevents visual inspection of the level of eluate in the container. Educated guesswork and/or trial and error are generally used to interrupt the elution based on an estimate of how much eluate is in the container. However, use of this method can easily lead to overfilling or underfilling of a container, both of which may result in undesirable inefficiencies. Even if it is possible for a person to visually monitor the level of eluate in the container (e.g., through a leaded glass window in the radiation shield), a person would have to dedicate some of his or her attention to monitoring the elution process to stop it at the right time. This would detract from the person's ability to do other things. Further, if the person were distracted, it would be easy to fill the container more than intended.

Thus, some may say there is a need for a radioisotope generation system that facilitates dispensing of a desired amount of eluate from a radioisotope generator.

### SUMMARY

One aspect of the invention is directed to a radioisotope generation system for dispensing a radioactive eluate (i.e., an eluate including a radioisotope) into a container for holding such an eluate. A radioisotope generator of the system is operable to dispense the eluate into the container. While the eluate is being dispensed by the generator into the container, a monitoring system monitors the amount of eluate dispensed into the container and generates a signal indicative of the amount of eluate dispensed into the container.

Another aspect of the invention is directed to a radioisotope generation system having a radioisotope generator that is operable to dispense radioactive eluate. An elution shield of the system has an internal cavity for receiving the eluate dispensed from the generator and is constructed at least in part of a radiation-absorbing material. A monitoring system monitors the dispensing of eluate by the generator to the cavity of the shield and is operable to generate a signal in response to the dispensing of a desired amount of eluate into the cavity and/or the elapsing of a predetermined elapsed time during which eluate is dispensed into the cavity.

Still another aspect of the invention is directed to a radioisotope generation system that includes a radioisotope generator for dispensing radioactive eluate. This system also includes a dispensed eluate sensor that may be used to sense an amount of eluate that has been dispensed from the generator, and a signaling device that is communicatively connected with the sensor. Incidentally, “communicatively connected” or the like herein refers to a relationship of first and second components characterized in that at least an electrical signal can be conveyed at least from one of the components to the other.

Yet another aspect of the invention is directed to a method for dispensing a radioactive eluate. In this method, eluate is dispensed from a radioisotope generator into a container while the container and the generator are in fluid communication. Incidentally, “fluid communication” or the like herein refers to a relationship between at least first and second components of a system; this relationship being such that a substance(s) (e.g., a liquid and/or gas) may flow through the system at least from one of the components to the other. In any event, in this method, the dispensing of the eluate into the container is monitored (e.g., using one or more appropriate sensors). Further, a signal (e.g., visible and/or audible) indicative of an amount of eluate dispensed is provided.

Still yet another aspect of the invention is directed to a method of providing a radioactive eluate. In this method, eluate is dispensed from a radioisotope generator into a cavity of an elution shield. An amount of eluate in the cavity is monitored during at least a portion of the eluate being dispensed. A signal (e.g., visible and/or audible) is automatically generated in response to detecting a desired amount of eluate in the cavity and/or a passing of a predetermined elapsed time during which the eluate is dispensed.

In yet another aspect, the present invention is directed to a method of providing a radioactive eluate. In this method, eluate is dispensed from a radioisotope generator into a container while the container and the generator are in fluid communication. An amount of the eluate that is dispensed into the container is determined, and a signal (e.g., visible and/or audible) is electronically triggered as a result of the amount of eluate that is determined (e.g., a threshold amount).

In still yet another aspect of the invention, an amount of radioactive eluate eluted from a radioisotope generation system in an elution procedure is determined. In addition, an electrical condition of the system is changed based on the amount of eluate that is determined to be eluted. By way of example, a change in electrical condition may refer to a closing and/or opening of an electrical circuit of the system. As another example, a change in electrical condition may refer to an alteration of an electrical signal between first and second components of the system. As still another example, a change in electrical condition may refer to a change in capacitance between first and second electrical conductors of the system.

Various refinements exist of the features noted in relation to the above-mentioned aspects of the present invention. Further features may also be incorporated in the above-mentioned aspects of the present invention as well. These refinements and additional features may exist individually or in any combination. For instance, various features discussed below in relation to any of the illustrated embodiments of the present invention may be incorporated into any of the aspects of the present invention.

### BRIEF DESCRIPTION OF THE DRAWINGS

FIG. 1 is a schematic diagram of a radioisotope generation system according to one embodiment of the present invention;

FIG. 2 is an enlarged view of a portion of the system of FIG. 1 illustrating a monitoring system thereof;

FIG. 3 is a schematic diagram of a radioisotope generation system similar to the system of FIG. 1 but further having an automatic interruption system.

FIG. 4 is an enlarged schematic diagram of an alternative embodiment of the monitoring system of FIGS. 1 and 3;

FIG. 5 is an enlarged schematic diagram of a monitoring system according to another alternative embodiment;

FIG. 6 is an enlarged schematic diagram of a monitoring system of still another alternative embodiment;

FIG. 7 is a schematic diagram of an alternative embodiment of a radiation generation system of the present invention; and

FIG. 8 is a schematic diagram of one embodiment of a selector useful with the radiation generation system of FIGS. 1, 3 and 7.

Corresponding reference characters indicate corresponding parts throughout the drawings.

### DETAILED DESCRIPTION OF ILLUSTRATED EMBODIMENTS

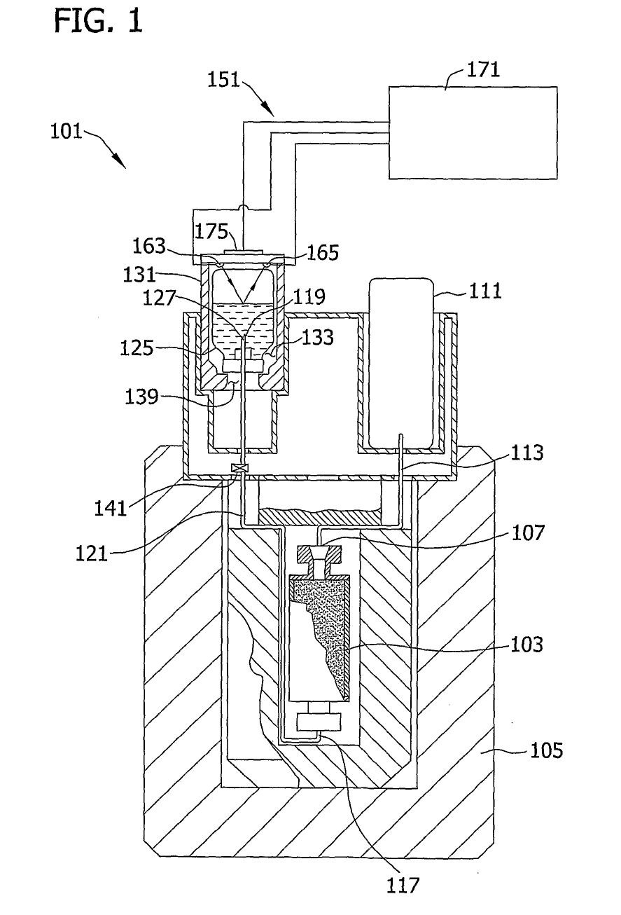

Referring now to the drawings, an in particular to FIG. 1, a radioisotope generation system of the present invention is generally designated 101. The system comprises a radioisotope generator having a column 103 containing a carrier, having a parent radioisotope (e.g., Molybdenum-99) that decays into a daughter radioisotope (e.g., Technetium-99m), adsorbed thereon. The generator column 103 may be enclosed in a conventional radiation-shield 105 as shown in the embodiment of FIG. 1. The generator column 103 has an inlet 107, which may be connected to an eluant reservoir 111 by a suitable inlet conduit 113. The column 103 also has an outlet 117 that may be connected to a tapping point 119 by a suitable outlet conduit 121.

The eluant reservoir 111 contains eluant (e.g., saline solution or other fluid capable of eluting the daughter radioisotope from the generator column), with the reservoir sized to contain enough eluant for multiple elutions. However, the eluant reservoir may alternatively be sized to contain no more eluant than is sufficient for a single elution without departing from the scope of the invention. The eluant reservoir may be a flexible (e.g., collapsible) bag or a substantially rigid container without departing from the scope of the invention. Where the container is rigid, a pressure relief system (e.g., a filtered vent to atmosphere) may be used so that withdrawal of eluant from the eluant reservoir does not create a vacuum in the eluant reservoir. The eluant reservoir 111 may be suitably mounted on the system 101 above the level of the generator column 103 as shown in FIG. 1.

The tapping point 119 may be constructed to allow a container 125 to be mounted thereon for fluid communication between the container and the generator column 103 via the outlet conduit 121. For example, in one embodiment (illustrated in FIG. 1) a hollow needle 127 capable of piercing a septum on the container 125 may be attached to the end of the outlet conduit 121 to serve as the tapping point. The system 101 may be configured so the tapping point 119 is above the level of the generator column 103 as in the illustrated embodiment. The system 101 may be configured so that the tapping point 119 is also at about the same level as the eluant reservoir 111.

The radioisotope generation system 101 may further comprise an elution shield 131 constructed to have an internal cavity 133 for receiving the eluate from the generator column 103 via the output conduit 121 and tapping point 119. In particular embodiments, the elution shield 131 may be constructed to house the container 125 within the internal cavity 133 thereof with the container connected to the generator at the tapping point as illustrated in FIG. 1. For example, the elution shield 131 shown in the drawings is constructed to have a cavity 133 sized and shaped to hold the container 125 and an opening 139 through which the needle 127 may be inserted to provide fluid communication between the container and the generator column 103 while the container is in the cavity. Other configurations of the radioisotope generation system are also contemplated to be within the scope of the invention, as long as the system is operable to dispense eluate to the cavity of the elution shield, and in particular embodiments to a container disposed in the cavity.

Fluid flow through the system 101 may be suitably controlled by one or more valves. For example, the system 101 may include at least one pinch valve 141, which is operable to selectively block the flow of eluate through the outlet conduit 121 to the container 125 (broadly, the internal cavity 133 of the elution shield 131). The pinch valve 141 may in part define an interruption system of the type described in U.S. Pat. No. 4,387,303, which is hereby incorporated by reference to the extent it is consistent, for allowing the flow of eluate to from the generator column 103 to the container 125 to be interrupted before the container is filled to its maximum volume. The term “maximum volume” as used in reference to the container 125 refers to that volume to which an evacuated container would be filled if the elution process were allowed to proceed until the pressure in the container increased enough to stop the inflow of fluids.

The elution shield 131 may comprise one or more radiation-absorbing materials (e.g., lead, tungsten, depleted uranium, etc.) to protect workers from radiation emitted by the eluate after it is received in the container 125. Those skilled in the art will know how to construct an elution shield having a sufficient amount of radiation-absorbing material in view of the type and amount of radiation expected to provide a desired level of protection against radiation exposure. The elution shield 131 may be substantially opaque, as indicated in the drawings, which inhibits manual monitoring of the amount of eluate in the container 125. However, the present invention is not limited to generation systems having opaque elution shields. Accordingly, an elution shield having a viewing window (e.g., leaded glass window) that allows viewing of the contents of the elution shield is contemplated to be within the scope of the invention.

The generation system 101 also comprises a monitoring system 151 capable of automatically monitoring the dispensing of eluate from the generator column 103 to the container 125, e.g., to monitor the amount of eluate dispensed into the container (broadly, into the cavity 133). The monitoring system 151 may generally be any system operable to automatically determine (e.g., sense, measure, meter, calculate, or otherwise gauge) the amount of eluate in the container 125 as eluate is dispensed from the generator column 103 into the container. For example, a radioisotope generation system may include a dispensed eluate sensor capable of determining the amount of eluate eluted from a generator communicatively connected to a signaling device. The dispensed eluate sensor may be a component of the elution shield 131, associated with other components of a radioisotope generation system or even be characterized as a component of the system in and of itself. It is contemplated that the monitoring system 151 may be operable to monitor the dispensing of eluate on a substantially continuous basis or on an intermittent basis.

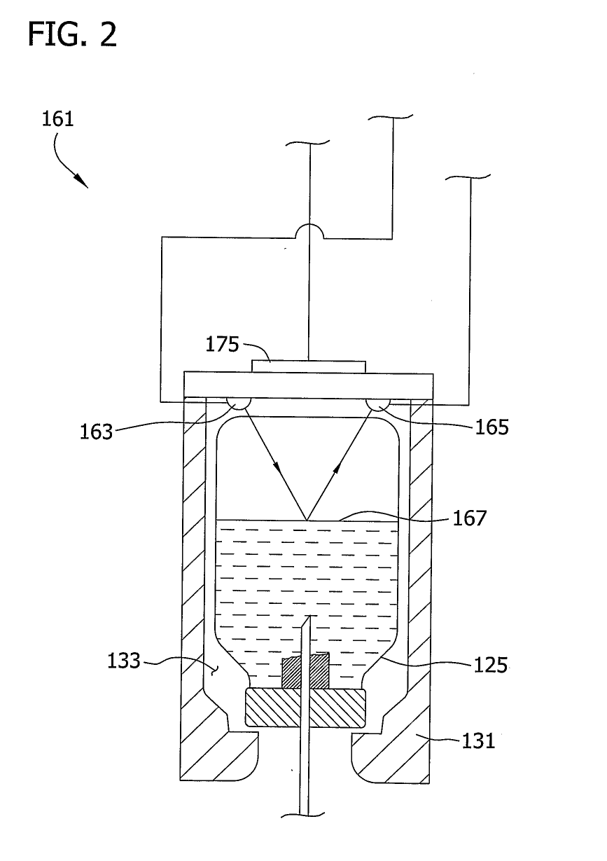

Referring to FIG. 2, one embodiment of a suitable monitoring system comprises a liquid level sensor 161 capable of detecting the level of the eluate in the container 125. For example, an infrared LED 163 and corresponding infrared detector 165 (e.g., photo diode) may be mounted inside the cavity 133 of the elution shield 131 in spaced relation to one another. The LED 163 (upon operation of the monitoring system) emits light (e.g., infrared light) which reflects off the upper surface 167 of the liquid back to the detector 165. Data from the detector 165 is transmitted (e.g., by hardwiring or wireless transmission) to a suitable processor 171 having circuitry and/or software enabling it to determine the path length of the reflected light based on the data, and thereby to determine the fluid level of the eluate in the container 125 as a function of the path length of the reflected light. The teachings disclosed in U.S. Pat. No. 5,291,031, which is hereby incorporated by reference to the extent it is consistent, may be used to construct a suitable processor capable of measuring the path length of the reflected light. It is contemplated that the container may be configured (e.g., contoured) to alter the path of light from the LED 163 to the upper surface 167 of the liquid and/or from the upper surface of the liquid to the infrared detector 165 to facilitate operation of level sensor 161. For example, the container may focus the light in a manner analogous to a lens. It is also contemplated that one or more lenses that are distinct from the container may be used to focus the light. Further, the use of the level sensor 161 without any lenses and/or with a container that is not configured to modify the path of light in any particular way is within the scope of the invention.

The fluid level in the container 125 corresponds to the amount of eluate in the container. Accordingly, the processor 171 (FIG. 1) is also capable of determining the corresponding amount of eluate in the container 125 based at least in part on the determined fluid level in the container. In particular embodiments, the processor 171 may further compare the determined amount of eluate in the container 125 to a desired amount of eluate to be dispensed into the container.

The monitoring system 151 is further operable to generate a signal once it determines that a desired amount of eluate has been received by (e.g., dispensed into) the container 125 (broadly, the internal cavity 133 of the elution shield 131). In one embodiment, the signal may be perceptible exterior of the elution shield 131, and in particular it may be perceptible to humans (such as radiopharmacists or other operators of the generation system). For example, the signal may be a light (broadly, a visual signal) or noise (broadly, an audible signal) perceptible to workers to alert them that it is time to interrupt the elution process. The monitoring system 151 illustrated in FIGS. 1 and 2, for instance, comprises a piezoelectric speaker 175 (broadly, a signaling device) activated by the processor 171 once the processor determines that the desired amount of eluate has been dispensed into the container 125 to make an audible noise perceptible to a worker in the vicinity. The signaling device may be a component of the elution shield 131, as indicated for example by connection of the piezoelectric speaker 175 to the elution shield in FIG. 2. In some embodiments, the processor 117 may function as a signaling device and may be operable to change an electrical condition of the system (e.g., open and/or close a circuit of the system, change a voltage applied to one or more components of the system, etc.) in a manner that is in and of itself imperceptible to unaided humans, although such a change in an electrical condition of the system by the processor may ultimately produce a tangible result (e.g., activation of an interruption system as described below) that may be perceptible to humans, if any are in a position to observe the result.

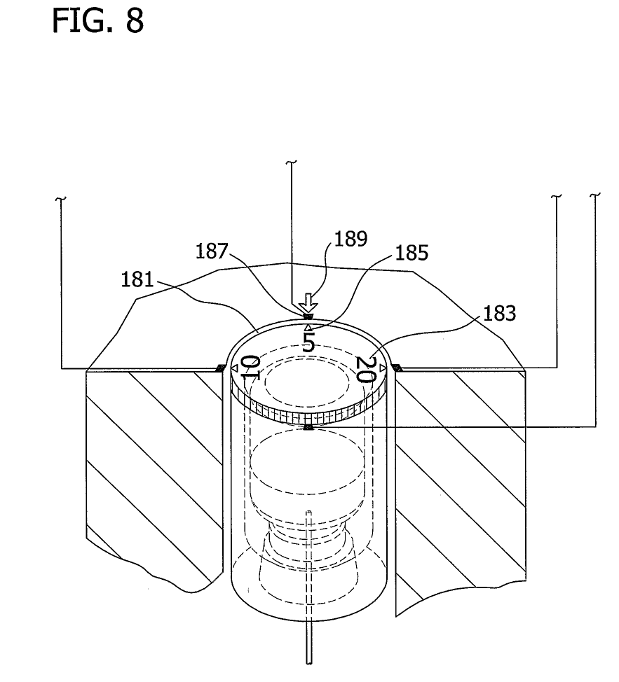

The generation system 101 may also comprise a selector in communication with the processor 171 and operable to allow a user to pre-select (e.g. prior to operation of the radioisotope generator to dispense eluate into the container) the desired amount of eluate to be dispensed into the container 125. Virtually any device capable of providing user input to the processor 171 can be used as the selector. For example, the selector may comprise a hall effect sensor dial 181 as illustrated in FIG. 8, a set of buttons, a potentiometer, a touch screen display, a computer terminal, or the like. The selector may be operable to allow the user to pre-select the desired amount of eluate from a set of predetermined desired amounts. For example, in the illustrated embodiment of FIG. 8, the hall effect sensor dial has indicia 183 that indicates the desired amount of eluate to be dispensed and a set of magnetic elements 185 and hall effect sensors 187 positioned to determine which of the indicia is aligned with a fixed marking 189 (e.g., a selection arrow). In other embodiments, the selector may instead be operable to allow the user to select any desired amount of eluate within a range of permissible amounts. For example, the selector may allow the user to select a set amount of eluate, or the selector may allow the user to select a certain fill percentage (e.g., 25%, 50%, etc.) of the container.

It is understood that the system 101 may also permit the user to opt to fill the container 125 to its maximum volume, such as by including on the selector a setting for disabling the monitoring system 151 or selecting a desired amount of eluate about equal to the maximum volume of the container. It may be more desirable to stop the dispensing just before the container 125 is filled to its maximum volume (e.g., to facilitate piercing the septum of the container to draw eluate into a syringe) rather than disable the monitoring system 151.

According to one embodiment of a method of the present invention for dispensing a desired amount of eluate to the container 125 (broadly, the cavity 133 of the elution shield 131), a user uses the selector to pre-select a desired amount of eluate to be dispensed from the generator column 103 into the container. An evacuated container 125 may be loaded into the elution shield 131 and connected to the generator column 103 by insertion of the needle 127 through a septum of the container. The pinch valve 141 may be opened (if it was initially closed) such that the vacuum pressure in the container 125 induces the eluant to flow from the eluant reservoir 111, through the inlet conduit 113 and into generator column 103 while eluate comprising the desired daughter radioisotope flows out of the generator column, through the outlet conduit 121, and into the cavity 133, and in the illustrated embodiment into the container. The vacuum pressure in the evacuated container 125 may induce the flow without pressurizing either the eluant or eluate above atmospheric pressure.

The monitoring system 151 monitors the dispensing of eluate into the container 125. For example, for the embodiment illustrated in FIGS. 1 and 2, the infrared LED 163 may emit light that is detected by the detector 165 after reflecting off of the upper surface 167 of the eluate in the container 125. The processor 171 determines the amount of eluate in the container 125 based on the fluid level data it receives from the detector 165. When the processor 171 determines that the amount of eluate in the container 125 is in a range from about equal to through greater than the pre-selected desired amount of eluate, the processor activates the piezoelectric speaker 175 (e.g., by changing a voltage applied to one or more electrodes of the piezoelectric speaker) to produce an audible signal. The processor 117 may activate the piezoelectric speaker when it determines a threshold amount of eluate has been eluted from the generator 103. In one embodiment, the processor 117 activates the piezoelectric speaker just before the amount of eluate in the container reaches the desired amount of eluate to account for the expected delay between activation of the speaker 175 and manual interruption of the elution process.

A person in the vicinity of the radioisotope generation system 101 (e.g., a radiopharmacist or other worker) may perceive the signal (e.g., see in the case of a visual signal and/or hear in the case of an audible signal) from the monitoring system 151 and thereby be alerted to the fact that the desired quantity of eluate has been dispensed into the container 125. The person may then interrupt the flow of eluate into the container 125 (e.g., by manually closing the pinch valve 141 and/or by disconnecting the container 125 from the outlet conduit 121). After the radioisotope generation process is complete, the user may use the selector to change the desired amount of eluate to a different amount and repeat the process to obtain a different amount of eluate in another container.

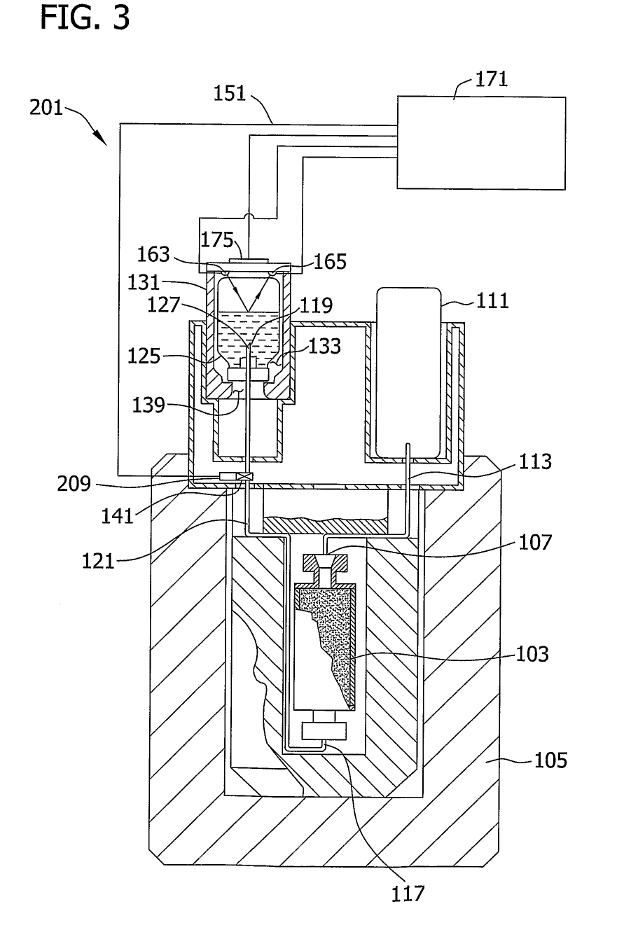

With reference now to FIG. 3, in another embodiment of a radioisotope generation system 201 of the present invention the system may further comprise an interruption system operable to automatically (as opposed to manually) interrupt the dispensing of eluate into the container 125 in response to an electronic signal generated by the monitoring system 151 once the determined amount of eluate in the container is approximately equal to the desired amount of eluate. For example, the processor 117 may alter an electrical condition of the system (e.g., open and/or close a circuit of the system, change a voltage applied to a component of the system, etc.) to activate the interruption system. It is understood that the electronic signal generated by the monitoring system 151 to activate the interruption system may be instead of, or in addition to, a signal that is perceptible exterior of the elution shield 131 (e.g., an audible or visible signal).

The interruption system may comprise a valve actuator 209 operable to close the pinch valve 141 in response to the signal from the monitoring system 151. Other suitable interruption systems may comprise an actuator (not shown) operable to disconnect the container 125 from the generator column 103 by withdrawing the needle 127 from the container in response to the signal from the monitoring system 151, such as by movement of the container, movement of the needle, or both. Construction and operation of the generation system 201 of FIG. 3 is otherwise substantially the same as the construction and operation of the system 101 of FIG. 1.

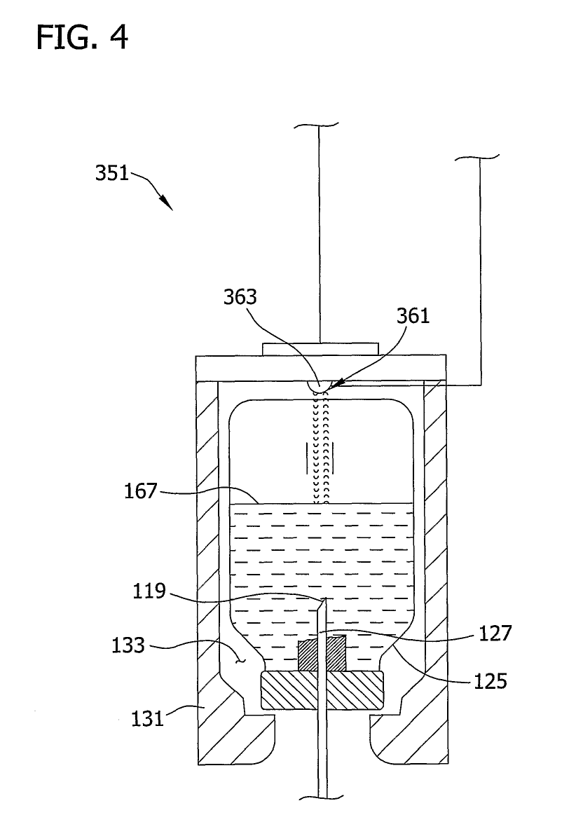

It is understood that suitable monitoring systems other than that illustrated in FIGS. 1-3 and described previously may be used without departing from the scope of this invention. For example, FIG. 4 illustrates a portion 351 of one alternative embodiment of a suitable monitoring system comprising an ultrasonic liquid level sensor 361 having an ultrasonic transmitter and receiver (e.g., a resonator 363 that transits ultrasound in an active mode and receives ultrasound in a passive mode) mounted in the cavity 133 of the elution shield 131. Operation of the liquid level sensor 361 shown in FIG. 4 involves emitting ultrasonic energy (e.g., a burst or chirp) from the transmitter 363 and detecting the echo of the ultrasonic energy reflecting off the fluid level surface 167 of the eluate. Data from the ultrasonic detector 363 may be transmitted (by wire or wirelessly) to the processor 171 whereby the processor determines the level of the eluate based on the data relating to the echo. The processor 171 may determine the amount of eluate in the container 125 (broadly, the cavity 133 of the elution shield 131) based at least in part on the determined fluid level of the eluate.

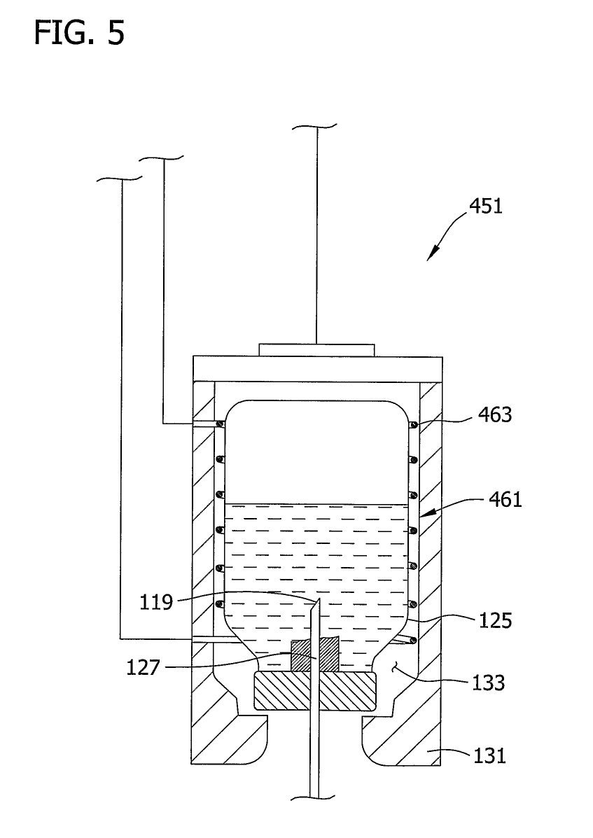

Another embodiment of a suitable monitoring system 451 is illustrated in part in FIG. 5. Such a monitoring system 451 comprises an inductive liquid level sensor 461. The inductive sensor comprises a conductive coil 463 turning about at least a part of the cavity 133 of the elution shield 131, and in the illustrated embodiment about the outer surface of the container 125 within the cavity. The inductance of the coil 463 may vary depending on the fluid level of eluate in the container 125. Operation of the monitoring system 451 of FIG. 5 may include measuring the inductance of the coil 463 and using the processor 171 to determine the level of eluate in the container 125 based on the inductance of the coil. Similarly, a capacitive sensor (not shown) comprising a pair of parallel conductors in opposing relation to one another may be positioned in the cavity so that the capacitance of the conductors varies depending of the level or eluate in the container 125, in which case the monitoring may include measuring the capacitance of the conductors and using the processor 171 to determine the level of eluate as a function thereof. As in previous embodiments, the fluid level of eluate corresponds to the amount of eluate in the container 125 (broadly, the cavity 133).

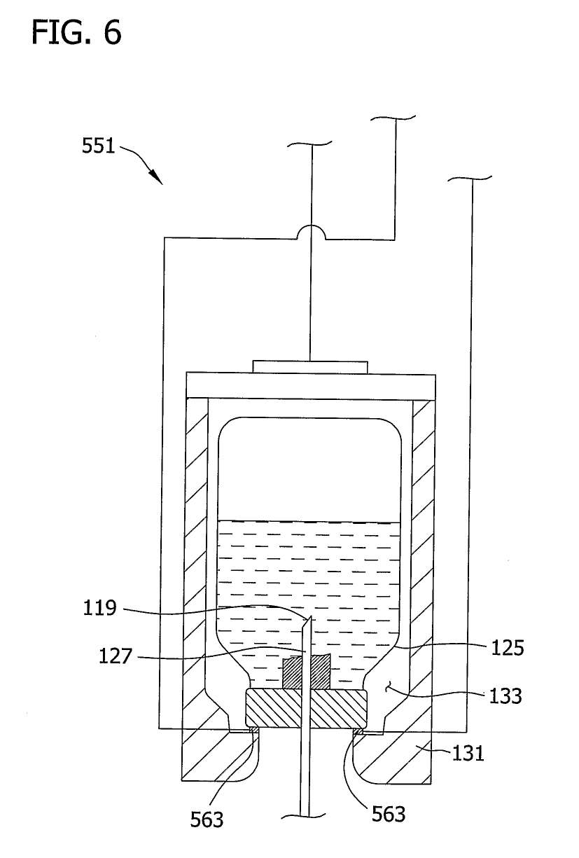

FIG. 6 illustrates part of yet another embodiment of a suitable monitoring system 551 in which the monitoring system comprises one or more pressure sensors 563 operable to determine the weight of the eluate in the container 125 (broadly, the cavity 133). For example, a pressure sensor 563 may be positioned in the cavity 133 of the elution shield 131 with the weight of the container 125 bearing down against the sensor. Data from the pressure sensor 563 may be sent to the processor 171, which correlates the pressure exerted on the pressure sensor to the weight of eluate in the container 125. The weight of the eluate corresponds to the amount of eluate in the container 125. A system incorporating the monitoring system 551 of FIG. 6 may otherwise operate substantially the same as the systems 101, 201 shown in FIGS. 1-3.

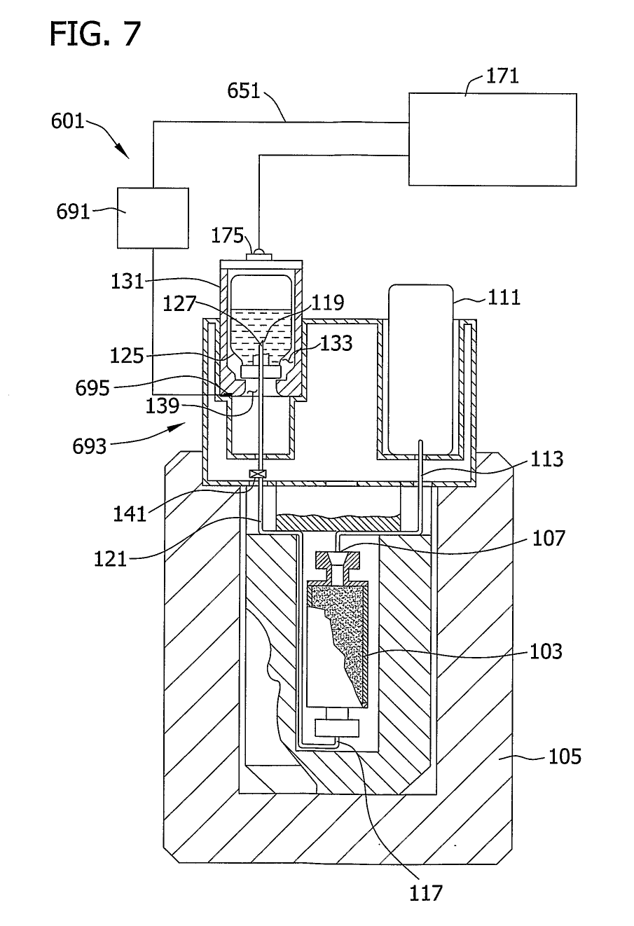

FIG. 7 illustrates another embodiment of a radioisotope generation system 601 of the present invention similar to the systems of FIGS. 1 and 3. The monitoring system of this embodiment, however, comprises a timer 691 operable to monitor an elapsed time during which eluate is dispensed from the generator column 103 into the container 125 (broadly, the cavity 133 of the elution shield 131). In particular, the elapsed time may be monitored relative to the time at which dispensing of eluate into the container 125 is initiated. The timer 691 can be used to gauge the amount of eluate dispensed into the container 125 based on previously calibrated data regarding the amount of time required for eluate to accumulate in the container under similar operating conditions. In this case, the monitoring system 651 may be operable to generate a signal in response to a predetermined elapsed time corresponding to a desired amount of eluate to be dispensed into the container 125. The selector may be operable to pre-select the predetermined elapsed time during which eluate is to be dispensed into the container 125.

In one embodiment the timer 691 may comprise a timer initiation system 693 adapted to start the timer automatically upon connection of the container 125 (and/or the elution shield 131) to the outlet conduit 121. For example, one or more sensors 695 (e.g., a hall effect sensor, optical sensor, RFID sensor, proximity sensor, or the like) may generate a signal upon connection of the container 125 to the outlet conduit 121. The timer 691 may be operable to begin monitoring the elapsed time in response to the signal indicating that the container 125 has been connected to the outlet conduit 121. Alternatively, the timer 691 may be started manually by a person when he or she connects the container 125 to the outlet conduit 121 without departing from the scope of the invention.

It is understood that the configuration of the radioisotope generation system can be different from the configurations discussed above and shown in the drawings without departing from the scope of the invention. Although the systems described and shown above involve dispensing of eluate into a container housed within an elution shield, it is understood that the elution system can dispense eluate directly into the cavity of the shield, or that the container may be unshielded, without departing from the scope of the invention.

Although a pinch valve is used to facilitate interruption of the elution in the illustrated embodiments, other types of valves could be used instead without departing from the scope of the invention. Likewise, the invention is operable without any valving as disconnection of the vacuum pressure source (e.g., the partially filled container) may be sufficient to interrupt the elution process in and of itself.

While in each of the illustrated embodiments the monitoring system generates a signal upon determining that the amount of eluate dispensed into the container is approximately equal to a desired amount of eluate, it is contemplated that the monitoring system may instead, or may additionally, generate a continuous or intermittent signal prior to the desired amount of eluate being dispensed into the container, e.g., indicative of the determined amount of eluate in the container (broadly, the cavity). For example, in one embodiment the signal may comprise visual or audible signals that indicate various incremental amounts of eluate dispensed into the container. Examples of such signals include, without limitation, lights, digital displays, alphanumeric displays or other suitable visual indicators of the amount of eluate dispensed into the container. Other examples include audible signals that may or may not increase in intensity as the amount of eluate in the container increases.

When introducing elements of the present invention or the preferred embodiments thereof, the articles “a”, “an”, “the”, and “said” are intended to mean that there are one or more of the elements. The terms “comprising”, “including”, and “having” are intended to be inclusive and mean that there may be additional elements other than the listed elements. Moreover, the use of “top” and “bottom” and variations of these terms is made for convenience, but does not require any particular orientation of the components.

As various changes could be made in the above products and methods without departing from the scope of the invention, it is intended that all matter contained in the above description and shown in the accompanying drawings shall be interpreted as illustrative and not in a limiting sense.

1. A radioisotope generation system comprising:
a radioisotope generator operable to dispense radioactive eluate into a container; and
a monitoring system operable while the radiation generator system dispenses eluate into the container to monitor the amount of eluate dispensed into the container and to generate a signal indicative of the amount of eluate dispensed into the container, the monitoring system comprising at least one of: (i) a level sensor operable to sense a level of eluate in the container, the level corresponding to the amount of eluate in the container; (ii) a timer operable to monitor an elapsed time during which eluate is dispensed into the container, the elapsed time being relative to a time at which the dispensing of eluate into the container is initiated, the elapsed time corresponding to the amount of eluate in the container; and (iii) a sensor operable to determine the weight of eluate in the container, the weight corresponding to the amount of eluate dispensed into the container.

2. A radioisotope generation system as in claim 1 wherein the monitoring system is operable to generate a signal when a desired amount of eluate has been dispensed into the container.

3. A radioisotope generation system as in claim 2 further comprising a selector for selectively setting the desired amount of eluate to be dispensed into the container.

4. A radioisotope generation system as in claim 2 wherein the generation system is operable to automatically interrupt dispensing of the eluate into the container in response to the signal.

5. A radioisotope generation system as in claim 1 wherein the signal is perceptible exterior of the container.

6. A radioisotope generation system as in claim 5 wherein the signal is at least one of visually and audibly perceptible exterior of the container.

7. A radioisotope generation system as in claim 1 wherein the signal is perceptible by a human.

8. A radioisotope generation system as in claim 1 wherein the level sensor is selected from the group consisting of optical sensors, infrared sensors, ultrasonic sensors, inductive sensors, and capacitive sensors.

9-10. (canceled)

11. A radioisotope generation system as in claim 1 wherein the monitoring system comprises the timer and is operable to generate a signal following dispensing of eluate into the container for a predetermined elapsed time wherein the predetermined elapsed time corresponds to a desired amount of eluate to be dispensed into the container.

12. A radioisotope generation system as in claim 11 wherein the predetermined elapsed time is selectively adjustable at least prior to the dispensing of eluate into the container being initiated.

13. A radioisotope generation system as in claim 1 further comprising a timer initiation system operable to automatically start the timer when dispensing of eluate into the container is initiated.

14. A radioisotope generation system as in claim 13 wherein the timer initiation system comprises a sensor selected from the group consisting of hall effect sensors, optical sensors, and RFID tags.

15. (canceled)

16. A method for dispensing radioactive eluate, the method comprising:
dispensing eluate from a radioisotope generator into a container while the container and the generator are in fluid communication;
monitoring the dispensing; and
providing a signal indicative of an amount of the eluate dispensed into the container, wherein the signal is perceptible by a human.

17. A method as in claim 16 wherein the providing comprises providing the signal when the amount of eluate in the container is approximately equal to a desired amount of eluate, the method further comprising interrupting the dispensing of eluate into the container in response to the signal.

18. A method as in claim 17 wherein the interrupting comprises automatically interrupting the dispensing of eluate into the container in response to the signal.

19. A method as in claim 17 wherein the interrupting comprises manually interrupting the dispensing of eluate into the container in response to the signal.

20. A method as in claim 17 further comprising selectively adjusting the desired amount of eluate to be dispensed into the container, the selectively adjusting being conducted prior to the dispensing of eluate into the container.

21. A method as in claim 16 wherein the monitoring comprises monitoring an elapsed time, starting from initiation of the dispensing, during which eluate is dispensed into the container, the elapsed time corresponding to the amount of eluate dispensed into the container.

22. A method as in claim 16 wherein the monitoring comprises sensing a level of eluate in the container, the level corresponding to an amount of eluate dispensed into the container.

23. A method as in claim 16 wherein the monitoring comprises sensing a weight of the eluate in the container, the weight corresponding to an amount of eluate dispensed into the container.

24. A method as in claim 16 further comprising generating an electrical signal based on the monitoring.

25. A method as in claim 24 wherein the providing results from the electrical signal generated.

26-57. (canceled)
